(19) United States
(12) Patent Application Publication
(10) Pub. No.: US 2002/0038610 A1
(43) Pub. Date: Apr. 4, 2002

(54) Apparatus for the alternative cleaning of two or more cylinders in a printing press, with a single cleaning device

(76) Inventors: Marco Corti, Lecco (IT); Riccardo Fumagalli, Oggiono (IT)

Correspondence Address: LARSON & TAYLOR, PLC, 1199 NORTH FAIRFAX STREET, SUITE 900, ALEXANDRIA, VA, 22314, US

(21) Appl. No.: 09/859,522

(22) Filed: May 18, 2001

(30) Foreign Application Priority Data
May 19, 2000 (IT) BO2000 A 000300

(51) Int. Cl. B41F 35/00; B41L 41/00

(52) U.S. Cl. 101/425

(57) ABSTRACT

A single cleaning device arranged parallelly between the cylinders (C1, C2), is secured to shoulders (F, F′) so as to realize a structure presenting a high resistance to torsion stresses, on the outer side of said shoulders there being provided, integral and projecting, identical pins (1, 1′) parallel to the longitudinal axis of the cleaning apparatus and axially aligned with respect to each other, which carry at their ends idle and identical rollers (6, 6′) which slide inside rectilinear guides (7, 7′) secured to the sides (S, S′) of the printing press and directed almost radially with respect to the one of the cylinders to be cleaned (C2) which presents surface gaps (G) which house clamps (E) and are provided with side cams (D). On said pins there are keyed toothed wheels (9, 9′), presenting identical features which tangentially mesh with rectilinear racks (10, 10′), which are identical, fixed and parallel to the said guides (7, 7′) and at least one of the said pins (1, 1′) or both being rotatably connected to respective brackets (3, 3′), connected to respective actuators (4, 4′) for alternate rectilinear motion anchored by their body to the sides (S, S′) of the printing machine and parallel to the said racks. By activating the said actuators the cleaning apparatus can be lifted and lowered and simultaneously rotate around the said end pins (1, 1′), so as to remain in a position strictly parallel to the cylinders and so as to be arranged with the cleaning units (P, T) at the level and perpendicularly with respect with either one of the cylinders to be cleaned. On said pins (1, 1′) there are coaxially mounted bearings or rollers (2, 2′), presenting a diameter such to cooperate with the side cams (D) of the cylinder presenting the gaps (G), so as to determine the automatic moving away from same of the cleaning means, in contrast to the elastic action of the said actuators (4, 4′), or of parts thereto associated.

### DESCRIPTION

The invention relates to an apparatus for the alternative cleaning of two or more near cylinders of a printing press with a single cleaning device.

Devices of this kind are for example described in the patents U.S. Pat. No. 5,408,930 (Loos) and U.S. Pat. No. 5,479,857 (Braun), in which the cleaning apparatus can swing around an axis parallel to the presser which can be thus alternately directed against either one of the two cylinders, which are near and parallel the one the other, of the printing press. Once the presser has been correctly directed with respect to a cylinder, the said presser is elastically deformed or is pushed in the direction of the cylinder itself, so as to carry into contact with same the cloth soaked with the cleaning liquids. These devices are not adapted for operating also onto cylinders provided with surface gaps which for example accomodate clamps, such as for example in the printing cylinders, in consideration of the fact that the cleaning cloth could interfere with the said clamps and could be torn. It is also known the device described in the document WO 00/34045 in the name of the same applicants, where the cleaning device is supported by means which upon control consent to same to perform a rotational or a swinging movement around a real or virtual axis, which is parallel and located between the two cylinders to be cleaned, while other suitable means compel the same cleaning device to effect a simultaneous rotational or swinging movement around its own longitudinal axis passing through the points of fastening to the said supporting means. This device, differently from those illustrated in the patents U.S. Pat. No. 5,408,930 (Loos) and U.S. Pat. No. 5,479,857 (Braun) above mentioned, is provided with a component of perpendicular displacement with respect to the cylinder to be cleaned, which is used so that the said device can automatically avoid interferences of the cleaning clothes with the clamps of a printing cylinder. For this purpose the cleaning device is provided on at least one end, with an idle roller which can cooperate with at least one cam mounted laterally on the printing cylinder in the zone if the clamps. Whenever the roller engages the said cam, the cleaning device is automatically moved away from the cylinder to be cleaned, thus avoiding interferences with the clamps and when the cam has been overcome the said cleaning device returns back to contact with the cylinder, thanks to the elastic thrust guaranteed by the pneumatic cylinders which control the shifting of the device in question.

The invention relates to a device which accomplishes the same functions as the device described in the document WO 00/34045 above mentioned, but which differently from this latter, results to be simplified in its construction inasmuch as it uses the same cleaning device as a torsion bar. The unit of the cleaning device is provided at its ends with pins which are parallel to the presser and aligned between one another, on the more projecting ends of which there are coaxially mounted respective idle rollers which slide inside rectilinear guides, fixed to the frame of the machine and directed almost radially with respect to the cylinder presenting the gaps. Onto said pins there are then keyed identical toothed wheels which mesh with respective racks which are fixed and parallel to the said rectilinear guides, so that the cleaning device can be shifted parallely to the cylinders by simultaneously rotating about itself, so as to be directed perpendicularly against either one of said cylinders. Onto said pins there are rotatably mounted brackets connected to the stem of pneumatic cylinders for lifting and lowering, so as to bring the device with the cleaning bar correctly directed and close to either one of the two cylinders to be cleaned. On the same axes there are finally coaxially mounted bearings which with their outer ring can cooperate with the cams arranged laterally to the printing cylinder, in the zone of the gaps.

Further characteristic features of the invention, and the advantages deriving therefrom, will appear better evident from the following description of one preferred embodiment, made merely by way of non limiting example in the figures of the attached sheets of drawings, in which:

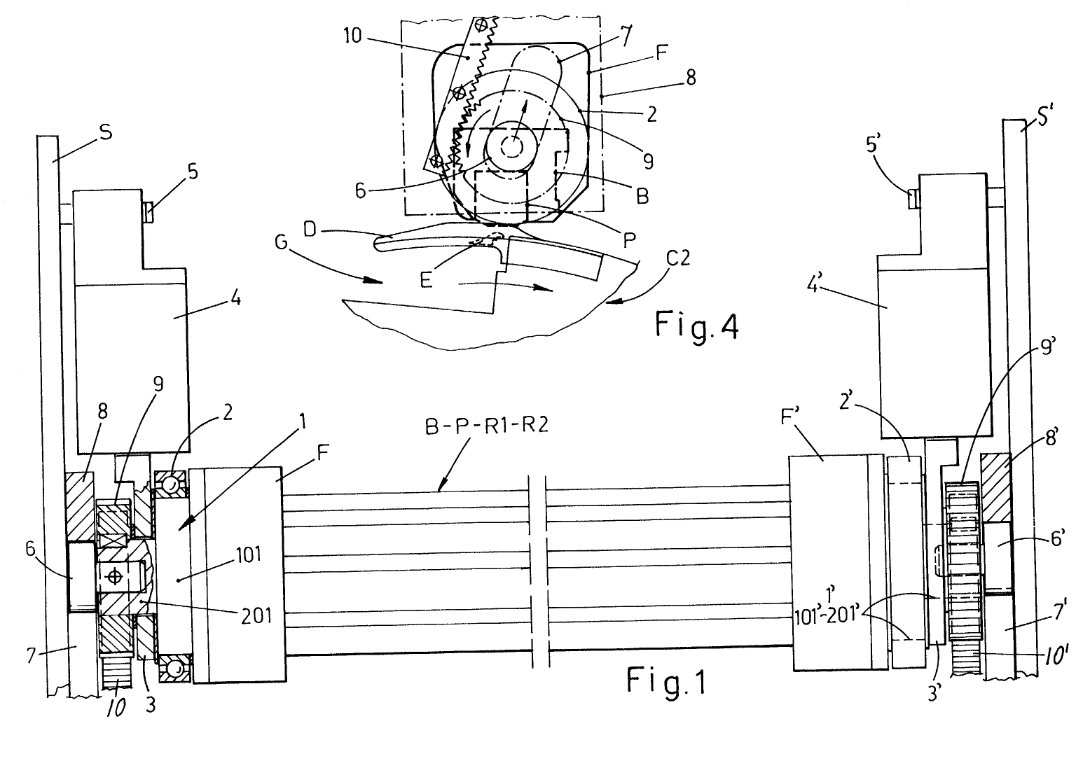

FIG. 1 is a front view and with parts in section of the apparatus;

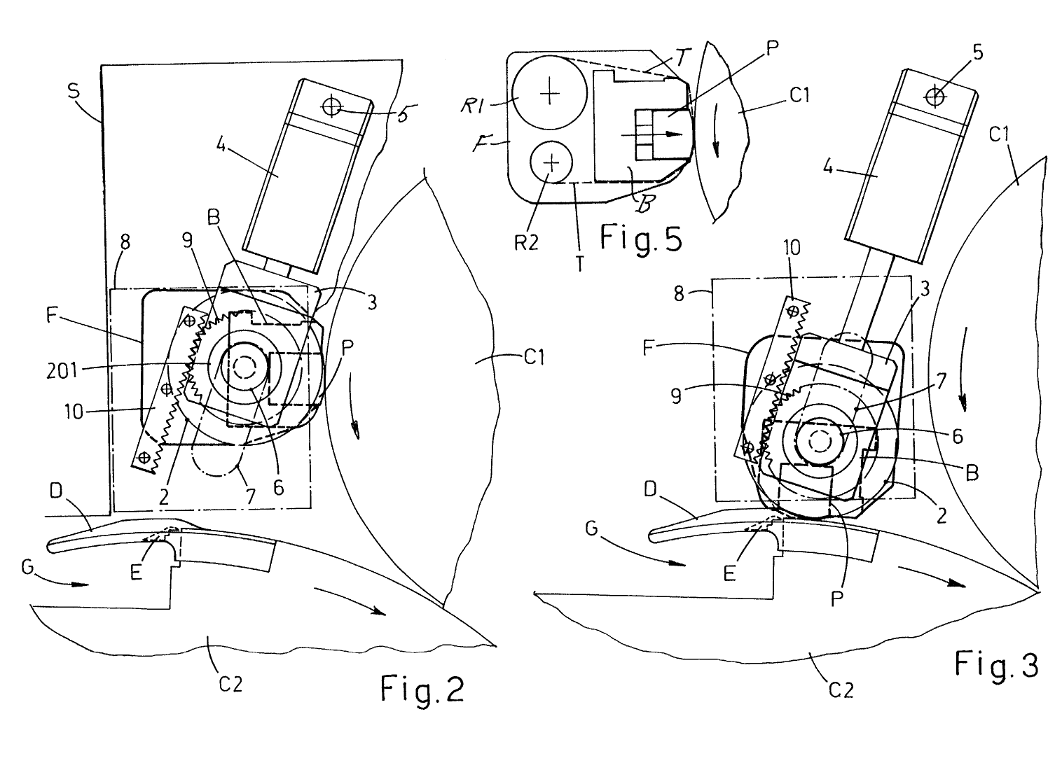

FIGS. 2, 3 and 4 are side views of the apparatus taken during its alternative co-operation with the two cylinders of the printing press;

FIG. 5 shows the device laterally and with further details which are not visible in FIGS. 2-4.

With reference to FIGS. 1 and 5 it is noted that the cleaning device comprises for example a strong bar B which carries movable parallely to itself, by own means, the presser P and which carries the assembly of the nozzles for dispensing the cleaning fluid onto the cloth T on its turn guided onto the assembly B, P unreeled from roller R1 and taken-up on roller R2, the said rollers and the said bar B being carried by shoulders F, F′. It is to be understood that the cleaning device can be of any known type and even different from the one previously mentioned, for example of the type which comprises a brush intended to contact the cylinder to be cleaned and onto which brush there is sprayed from the nozzles the cleaning liquid. The only condition which a cleaning device must have in order to be employed in the improvement according to the invention is that of forming together with the shoulders F, F′ a rigid structure presenting a high degree of resistance to the torsion stresses.

In FIGS. 2 and 3, C1 indicates the rubber cylinder and C2 indicates the printing cylinder with the gaps G which house the clamps E and presenting the lateral cams D at the level of said clamps. The cleaning device is arranged in the zone of reciprocal contact of the two cylinders to be cleaned C1 and C2, parallely thereto and comprises fixed perpendicularly on the outer side of the shoulders F, F′, parallely to the components B, P, R1, R2 and axially aligned between them, identical pins 1, 1′, subdivided in two portions 101, 101′ and 201, 201′ presenting a diameter decreasing towards the exterior.

On the portions 101, 101′ presenting a greater diameter, there are coaxially mounted bearings 2, 2′ presenting an identical diameter, intended to cooperate with the side cams D of the printing cylinder C2, arranged in the zone of the clamps E.

Onto the portions 201, 201′ presenting a smaller diameter of the pins 1, 1′, there are mounted rotatable the brackets 3, 3′ secured to the stem of pneumatic jacks 4, 4′ presenting identical features, anchored by their body at 5, 5′, to the sides S, S′ of the printing machine and directed with their longitudinal axis in a direction substantially radial with respect to the printing cylinder C2.

On the ends of the pins 1, 1′ there are secured projecting and coaxially the rollers 6, 6′ presenting identical features, which slide in rectilinear guide slots 7, 7′ parallel to the longitudinal axis of the jacks 4, 4′ and obtained in the plates 8, 8′, secured onto the above mentioned sides S, S′.

On the portions 201, 201′ of the pins 1, 1′ which are left free from the brackets 3, 3′ there are keyed toothed wheels 9, 9′ presenting identical features, which mesh with respective racks 10, 10′, parallel to the said slots 7, 7′, and secured onto the plates 8, 8′. It appears evident that following to actuation of jacks 4, 4′, the bar B together with the presser P can be brought in proximity either with cylinder C1 or with cylinder C2, while maintaining itself strictly parallel to said cylinders and simultaneously rotating about the axis of pins 1, 1′, so as to result alternately directed with said presser P perpendicularly towards either one or the other of the said cylinders. The cleaning device operates as a torsion bar and the two end pinions 9, 9′, together with the associated racks 10, 10′ act in such a manner that the angular and linear displacements of the opposite ends of the said device are strictly identical and synchronized, thus guaranteeing the more strict and constant parallelism between the said device and the cylinders to be cleaned.

From FIG. 2 it is noted that when the jacks 4, 4′ are at the end of the run of retraction of their stem, the rollers 6, 6′ bear against the upper end of the guide slots 7, 7′ and the presser P is directed and positioned for cleaning the rubber cylinder C1. When instead the jacks 4, 4′ are in the condition of extension of their stem, the rollers 6, 6′ bear onto the lower end of the slots 7, 7′ as shown in FIG. 3, and the presser P is directed and positioned for cleaning the cylinder C2. The bearings 2, 2′ are in this case positioned along the rotational orbits of the side cams D of cylinder C2, so that whenever these lafter cooperate with the said bearings 2, 2′ the whole cleaning apparatus is lifted and simultaneously it rotates of a small amount in anti-clockwise direction, as shown in FIG. 4, so as to avoid that the presser P together with the cleaning cloth T interfere with the clamps E of cylinder C2. This lifting movement takes place against the compression of air in the active chamber of the jacks 4, 4′, so that the apparatus automatically returns back to its operational position of FIG. 3 as soon as the system P-T has passed over the clamps E. The contour of the cams D will be such as to consent a progressive approach of the cleaning apparatus to the cylinder to be cleaned.

Whenever the cleaning apparatus is in its rest position, with the presser P retracted with respect to the active position according to FIGS. 2-5, the assembly BP can be placed in a position equidistant from cylinders C1, C2, with the rollers 6, 6′ positioned in the intermediate position of the guide slots, and suitable means can be provided to maintain the apparatus in this condition while the jacks 4, 4′ are deactivated. These means can comprise for example a servo-controlled latch, mounted on one of the shoulder S, S′ so as to be capable of entering into one of the slots 7, 7′ and of inserting itself under one of the rollers 6, 6′, or they can comprise at least one pawl hinged onto one of the brackets 3, 3′ cooperating with the nearby toothed wheel 9, 9′ so as to prevent its rotation in the direction which leads to the lowering of the apparatus and connected to a small servo-control for neutralization, pneumatically or electrically operated. In a different manner with respect to what illustrated, the lifting and lowering movement of the cleaning apparatus can be effected, instead of using a pneumatic jack 4, by means of a screw-and-nut jack, electrically operated or by means of other servo-control device with irreversible motion, if not desired. In this case, the movable element of said irreversible system will be connected to the bracket 3 with the interposition of a small telescopic means normally extended, for example a spring of a gas shock absorber, in order to ensure the correct operation of the apparatus in its co-operation with the cams D of cylinder C2. All these means have not been illustrated inasmuch as they are conceivable and can be easily constructed by the person skilled in the art, based on the above description.

It is to be understood that, by suitably dimensioning the respective components, the apparatus can be used also for the cleaning of a third cylinder which co-operates for example with cylinder C1 and is opposed to cylinder C2.

1) apparatus for the alternative cleaning of two or more cylinders (C1, C2) in a printing press with a single cleaning device arranged parallelly between the said cylinders,
characterized by the fact that
the said apparatus is secured to shoulders (F, F′) so as to realize a structure presenting a high resistance to torsion stresses, on the outer side of said shoulders there being provided, integral and projecting, identical pins (1, 1′) parallel to the longitudinal axis of the cleaning apparatus and axially aligned with respect to each other, which carry at their ends idle and identical rollers (6, 6′) which slide inside rectilinear guides (7, 7′) secured to the sides (S, S′) of the printing press and directed almost radially with respect to the one of the cylinders to be cleaned (C2) which presents surface gaps (G) which house clamps (E) and are provided with side cams (D), there being on said pins keyed toothed wheels (9, 9′), presenting identical features which tangentially mesh with rectilinear racks (10, 10′), which are identical, fixed and parallel to the said guides (7, 7′) and at least one of the said pins (1, 1′) or both being rotatably connected to respective brackets (3, 3′), connected to respective actuators (4, 4′) for alternate rectilinear motion anchored by their body to the sides (S, S′) of the printing machine and parallel to the said racks, the whole in such a manner that by activating the said actuators the cleaning apparatus can be lifted and lowered and simultaneously rotate around the said end pins (1, 1′), so as to remain in a position strictly parallel to the cylinders and so as to be arranged with the cleaning units (P, T) at the level and perpendicularly with respect with either one of the cylinders to be cleaned, on said pins (1, 1′) there being coaxially mounted bearings or rollers (2, 2′), presenting a diameter such to cooperate with the side cams (D) of the cylinder presenting the gaps (G), so as to determine the automatic moving away from same of the cleaning means, in contrast to the elastic action of the said actuators (4, 4′), or of parts thereto associated.

2) Apparatus according to claim 1, in which the rectilinear guides (7, 7′) inside which there slide the end rollers (6, 6′) of the said apparatus, consist of slots obtained in plates (8, 8′), secured to the sides (7, 7′) of the printing machine.

3) Apparatus according to claim 2 in which the racks (10, 10′) are secured on the plates (8, 8′) presenting the guides slots (7, 7′).

4) Apparatus according to claim 2, in which the guide slots (7, 7′) present such a length as to stop with their ends the run of the rollers (6, 6′) which slide inside same, when the cleaning device is located and is directed operatively against either one of the cylinders to be cleaned.

5) Apparatus according to claim 1, characterized by comprising means which maintain the cleaning device in a rest position which is substantially equidistant from the cylinders to be cleaned, even when the actuators (4, 4′) for the alternative displacement are deactivated.

6) Apparatus according to claim 1, characterized by the fact that the actuators (4, 4′) for the lifting or for the lowering of the said apparatus consist of pneumatic jacks.

7) Apparatus according to claim 1, characterized by the fact that the actuators (4, 4′) for the lifting or for the lowering of the said apparatus consist of electromechanical jacks, of the type presenting a screw and nut with electric drive, the mobile element of said jacks being connected to the brackets (3, 3′) by means of a telescopic unit with an elastic extension means, for example by means of a shock-absorber or a gas spring which are normally extended.
